(19) United States
(12) Patent Application Publication
(10) Pub. No.: US 2007/0186452 A1
(43) Pub. Date: Aug. 16, 2007

(54) Universal medicine bottle attachment

(76) Inventor: Frederick Alan Hirth, Anthem, AZ (US)

Correspondence Address: Russell W. Guenthner, 6403 W. Redfield Road, Glendale, AZ, 85306, US

(21) Appl. No.: 11/351,730

(22) Filed: Feb. 10, 2006

(51) Int. Cl. G09F 3/00

(52) U.S. Cl. 40/310

(57) ABSTRACT

A device for attachment to a medicine bottle is disclosed. The device is intended as an aid to consumers in remembering information concerning a medication. The device provides a mechanism for conveniently attaching a label to a medicine bottle with the label being a blank area suitable for writing the purpose of the medication or any other information to help the consumer. The label is reusable for repeated attachment to refills of the same prescription medicine and is intended to be written on by either the pharmacist or the consumer in a language or with words which are understandable and clear to the consumer. The label is large enough to accommodate large writing for persons with poor eyesight. Additional features related to taking of a medication are provided as part of the device including a counting device with the appearance like that of the hands on a clock.

### FIELD OF THE INVENTION

A device for attachment to a prescription bottle or medicine bottle is disclosed. The device is an aid to consumers in remembering the purpose of a medication, or for other similar purpose. The device includes an area for a blank label that can be written upon by the consumer or the pharmacist. The device is intended to increase consumer confidence in selecting and taking the correct medicines regularly, and to describe the medicine to the consumer in terms that are understandable, or in a language or words that are an aid to the consumer. The label can be large enough to allow writing in large letters as an aid to persons with poor eyesight. The device includes mechanism in addition to the label for other reminder information related to the regular taking of medicine including a clock-like mechanism for remembering the number of times a medicine has been taken. The device can include physical attributes indicative of the type of medicine contained.

### BACKGROUND OF THE INVENTION

Prescription medicines often have names that may not be easily remembered or related by the consumer to the purpose of the drug. Labels on prescription bottles are often printed in smaller letters that are not easily read by older people or people with low eyesight. Some people may take multiple medicines each day which may come in similar packages or have similar, non-distinctive, or not easily remembered names. Many prescriptions or medications are taken regularly for long periods and are refilled on a regular basis such as once a month or once a week.

In the pharmacy, pharmacists are often asked to explain a medication in terms understandable to the consumer. Words such as “heart pill” or “water pill” or “skin cream” or “stomach medicine” may help the consumer understand the medicine more clearly than the medically correct name for a drug such as “potassium” or “hydrochlorothiazide” or “hydrocortisone” or “Zantac” (ranitidine hydrochloride).

The device disclosed as the subject invention is intended as a reusable attachment to a medicine bottle which provides a convenient place for the consumer or pharmacist to write or mark the purpose of the medicine upon the device attached to a medicine bottle. The device itself, or the label, can also include other information such as the number of times to be taken each day. Having a reusable device allows the consumer or the pharmacist to transfer the information to a new bottle when a prescription is refilled.

### OBJECTS OF THE INVENTION

It is therefore a broad object of this invention to provide a device which is an attachment for a medicine container with the attachment including an area serving as a label. The label area is for use by consumers of medicine as an aid to the consumer in remembering information about the medicine in a manner that is easier than that normally provided by reading the prescription label typically attached by adhesive to a medicine bottle. The device is reusable so that it can be easily transferred from one bottle to another when a prescription is refilled. The label area can be large enough to accommodate letters or writing that is large enough to be more easily read by people with poor eyesight than the print on the normal prescription label. The label area is textured and of material that is intended to make writing on the label reasonably permanent and not easily rubbed off in normal handling. Additional information in the form of physical attributes of the labeling device may be provided which are indicative of the medicine contained. The device may be provided in different sizes or forms which are amenable to being attached to bottles of different shapes or sizes. Other mechanism may also be included related to the number of times a medicine has been taken. Other mechanism may also indicate the time of day a medicine should be taken or the number of times already taken that day.

### SUMMARY OF THE INVENTION

Briefly, these and other objects of the invention are achieved by an overall approach and mechanisms to support that approach which improves the labeling of a medicine bottle such that information related to the prescription or medicine is more readily read and understood by the consumer. The device includes as the first part a label surface for writing information related to the medicine. The area of the label surface for writing may be large enough such that the writing is easily readable by the consumer, and the size of the label may vary depending on the amount of information to be written, or the clarity of the consumer's eyesight. The label surface can be of texture and porosity such as to readily allow writing on the surface with an ordinary ballpoint pen or permanent marker. The surface should also be of texture and porosity such that writing will not easily be erased or rubbed off with casual handling or incidental rubbing. Materials of this type are readily available.

The device includes as a second part a mechanism for attaching the label surface to a medicine bottle. In a first exemplary embodiment, the mechanism for attachment consists of curved plastic extensions of the label designed to be placed around the medicine bottle and which hold the label firmly in place. The mechanism for attaching the device to the medicine bottle is intended to allow the device to be removed and attached again to another medicine bottle when the prescription is refilled. Other mechanisms for attachment are readily apparent which provide similar functionality.

The device includes as an optional third part an indicative feature on the device which or serves as a reminder of the contents of the medicine container. As an example, a protruding feature consisting of a molded shape which looks like a mortar and pestle could identify and be indicative simply that the container holds medicine. Another example could be the shape of a heart for heart medicine. A second or alternative indicative feature might be in the shape of a number which indicates the number of times the medicine is to be taken each day. Multiple features indicative of either alternative or conjunctive things to remember could be provided. The indicative features could also be molded into the surface of the device instead of protruding from the device.

The device includes as an optional fourth part a mechanism for recalling the number of times that a medicine has been taken each day. As an exemplary implementation this is a dial that resembles the hands on a clock which can be rotated to indicate the number of times a medicine has been taken.

### DESCRIPTION OF THE DRAWING

The subject matter of the invention is particularly pointed out and distinctly claimed in the concluding portion of the specification. The invention, however, both as to organization and method of operation, may best be understood by reference to the following description taken in conjunction with the subjoined claims and the accompanying drawing of which:

FIG. 1 is a diagram showing a typical medicine bottle of the prior art with standard label affixed by adhesive;

FIG. 2 shows as a first embodiment a medicine bottle with an exemplary label device of the subject invention attached;

FIG. 3 is a sketch showing the label area provided as part of the label device with an area for writing information about the medicine to which the device will be attached;

FIG. 4 is a sketch showing an exemplary label device of the subject invention with a larger label providing a larger area of writing to allow larger lettering for consumers with poor eyesight;

FIG. 5 is a sketch showing an indicative structure that can be part of the label device which provides a mechanical means for remembering how many times a medicine has been taken;

FIG. 6 is a sketch showing an exemplary label device of the subject invention including a second indicative structure that helps the consumer remember the medicine contained in the bottle to which the label device will be attached;

FIG. 7 is a sketch showing a second exemplary embodiment of the invention in which the device for attachment to the medicine bottle is constructed of a single piece of plastic of uniform width, with the plastic molded in a cylindrical shape that can be stretched to fit around medicine bottles of varying size. This second embodiment may be simpler and cheaper to manufacture than the first embodiment as depicted in FIG. 2.

### DESCRIPTION OF THE PREFERRED EMBODIMENT(S)

While the principles of the invention have now been made clear in an illustrative embodiment, there will be immediately obvious to those skilled in the art many modifications of structure, arrangements, proportions, the elements, materials, and components, used in the practice of the invention which are particularly adapted for specific environments and operating requirements without departing from those principles.

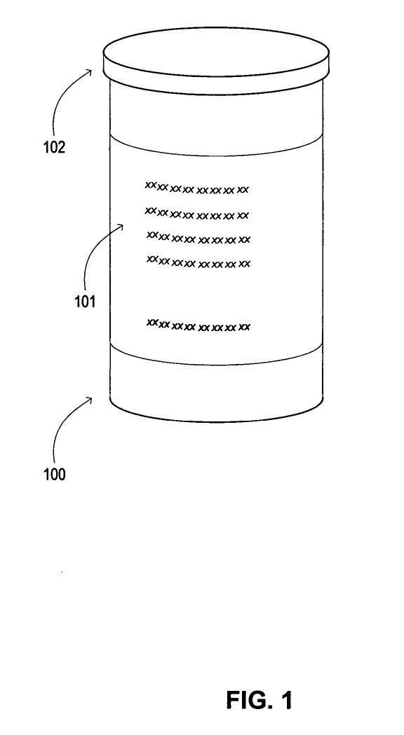

FIG. 1 is a diagram showing a typical medicine bottle 100 of the prior art with standard label 101 affixed to the surface of the bottle by an adhesive. The general overall shape of the exemplary bottle is that of a cylinder closed on one end with a removable cap 102 on the other end. Medicine bottles as used by pharmacies for many medicines, particularly pills, are often formed of plastic and are provided in an assortment of standard sizes and shapes.

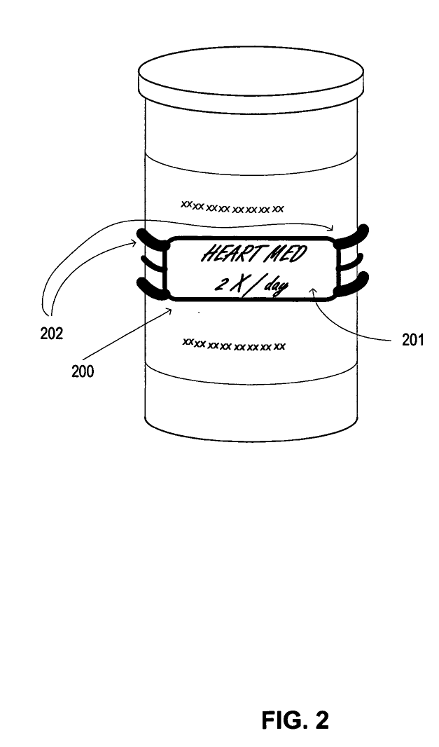

FIG. 2 shows a medicine bottle with an exemplary label device 200 of the subject invention attached. The device attaches to the medicine bottle and holds a writable label 201 in a manner such that it is readily examined and viewed. The mechanism for attachment is an extension of the writable consisting of arms 202 that are flexible and which wrap around the bottle to hold the writable label in place. The writable label provides a space for either the consumer or the pharmacist to write, typically in ink, information relating to the medicine in the container to which the device is attached. The writable label provides a means for the medicine to be described in “lay” terms, that is, using terms, writing, and language understandable or useful to a specific consumer or class of consumers. The area of the label is large enough to be easily written upon by hand using a pen or marker.

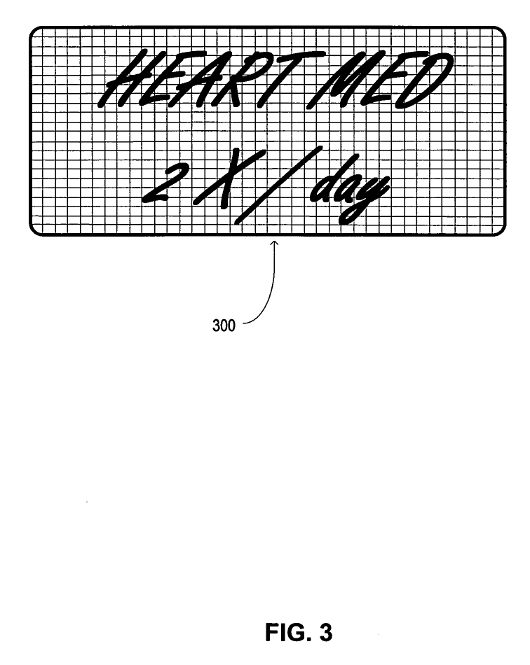

FIG. 3 is a sketch showing the surface of the label area 300 provided as part of the label device with an area for writing information about the medicine to which the device will be attached. The surface 300 as shown is textured and of porosity such that the ink of the writing upon the label will not be easily removed or rubbed off during casual handling of the medicine bottle.

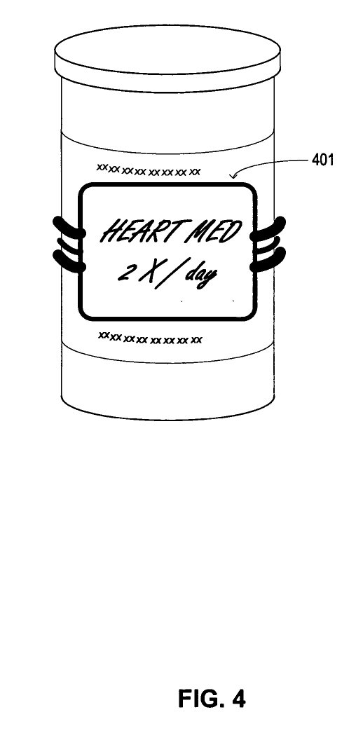

FIG. 4 is a sketch showing an exemplary label device of the subject invention with a larger label providing a larger area of writing 400 to allow larger lettering for consumers with poor eyesight.

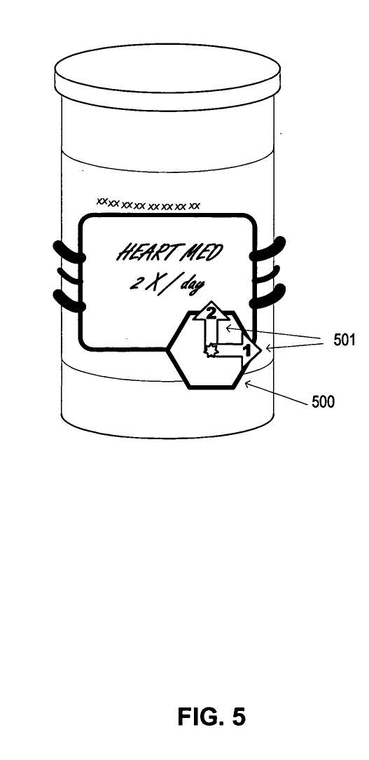

FIG. 5 is a sketch showing the exemplary label device of the subject invention including an indicative structure 500 which is an accounting mechanism. The accounting mechanism is a part of the label device and provides a mechanical means for remembering how many times a medicine has been taken. The exemplary indicative structure in the figure bears resemblance to a clock and the hands of a clock. The hands 501 are moveable. At the beginning of a day, the accounting mechanism is “reset” by putting the “hands” in an upward pointing (12 o'clock) position. Each time a dose of medicine is taken from the bottle, one of the hands is moved down to a position that is not at 12 o'clock. The consumer can thus readily determine how many times the contained medicine has been taken by simply glancing at the position of the hands. Different numbers of hands can be provided depending on the number of dosages for which accounting is desired. Other alternative mechanical means for accomplishing the same accounting are readily apparent and could be provided as an alternative accounting mechanism to the exemplary mechanism here described.

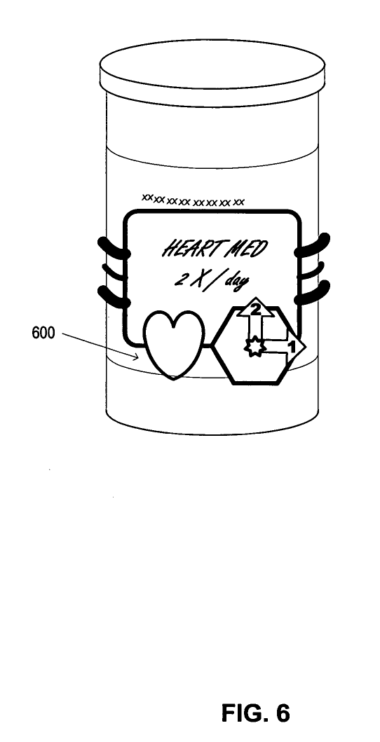

FIG. 6 is a sketch showing the exemplary label device of the subject invention including a second indicative structure 600 that helps the consumer remember the medicine contained in the bottle to which the label device will be attached. This structure could be any shape which reminds the consumer of the intended purpose of the medicine. In FIG. 6 the second indicative structure 600 is in the shape of a heart and reminds the consumer that the medicine bottle contains “heart” medicine.

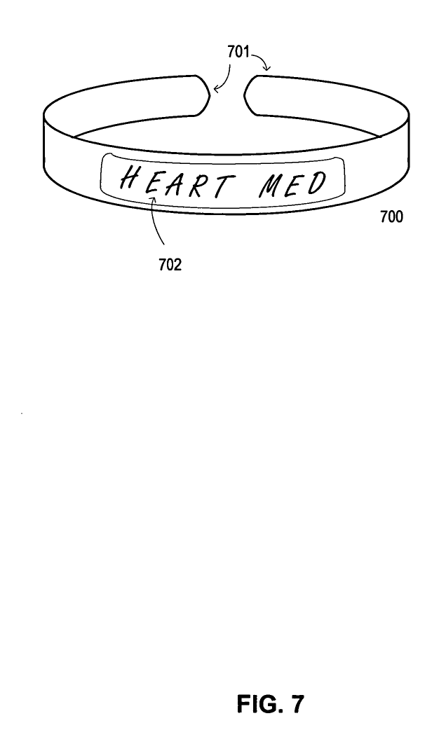

FIG. 7 is a sketch showing a second exemplary embodiment of the invention in which the device for attachment 700 to the medicine bottle is constructed of a single piece of plastic of uniform width, with plastic arms 701 molded in a cylindrical shape that can be stretched to fit around medicine bottles of varying size. The writable surface of the label 702 is also a part of the same single piece of plastic of uniform width. This second embodiment may be simpler and cheaper to manufacture than the first embodiment as depicted in FIG. 2.

In general terms, the figures of the drawing illustrate a device for attachment to a medicine container. Prescription medicine as it typically comes from the pharmacy is in a medicine bottle labeled with a piece of paper affixed with an adhesive label and placed around and upon the cylindrical surface of the bottle. The writing on the adhesive paper label typically provides a brief description of the medicine and the dosage in terms that are medically correct, but which may be confusing to a consumer, particularly if the patient is elderly or whose first language is not that used on the adhesive label. The subject invention provides a convenient means for either the pharmacist or consumer to attach further written information to the medicine bottle. The information, since it is written by hand, can be large enough and in any form that is helpful to the consumer. A care provider, nurse or relative of the patient would be able to express the description of the medicine in terms that are more understandable to the consumer of the medicine than typically provided by the information on the adhesive paper label.

In addition, the subject invention provides other physical indicators to aid the consumer in taking the correct dosage and the proper medicine. The first indicator is a mechanism for counting the number of times a medicine has been taken. The second indicative indicator is a physical structure which is a physical reminder to the consumer of the type of medicine contained in the bottle to which the label device is attached.

The device of the subject invention is re-usable in that it can be easily detached and moved to a new bottle when a prescription is refilled. The device can also be easily moved to reveal the original adhesive label as typically provided by the pharmacy.

The device can be made in plastic of different colors as a further aid or reminder as to which medicine is contained.

The overall result when using a device of the subject invention is to increase the confidence and accuracy in the taking or use of the medicine contained in the bottle to which the device is attached. The device incorporates several features which together are related to the medicine in any specific bottle to which the device is attached.

Thus, while the principles of the invention have now been made clear in an illustrative embodiment, there will be immediately obvious to those skilled in the art many modifications of structure, arrangements, proportions, the elements, materials, and components, used in the practice of the invention which are particularly adapted for specific environments and requirements of operation without departing from those principles.

What is claimed is:

1. An apparatus for attachment to a medicine container including:
A) a label with label surface such that it can be written upon by hand with a writing instrument;
B) an attachment mechanism which will attach said label to a medicine container;
C) said attachment mechanism being non-adhesive and allowing for the apparatus to be easily detached from the medicine container and then again attached;
D) said attachment mechanism allowing attachment to the medicine container after the container has been filled with medicine and after an adhesive label has been placed upon the container.

2. The apparatus of claim 1 in which:
A) said label surface is slightly textured such that ink forming the letters of writing upon the label surface is not easily rubbed off.

3. The apparatus of claim 2 including also:
A) a mechanical counting structure which can be manipulated to indicate to a consumer the number of times the medicine in the container has been taken.

4. The apparatus of claim 3 in which:
A) said mechanical counting structure includes hands that resemble those of a clock.

5. The apparatus of claim 1 including also:
A) decorative structure which is indicative that the medicine container contains medicine.

6. The apparatus of claim 1 including also:
A) structure which is indicative of the purpose of the medicine in the medicine container.

7. The apparatus of claim 3 including also:
A) decorative structure which is indicative that the medicine container contains medicine.

8. The apparatus of claim 3 including also:
A) structure which is indicative of the purpose of the medicine in the medicine container.

9. The apparatus of claim 1 in which:
A) the apparatus is made of a molded flexible plastic material such that it can be held in place attached to a medicine bottle by simply wrapping extensions of the label around the bottle.

10. The apparatus of claim 1 in which:
A) the apparatus once attached to a bottle is easily removable from the bottle.

11. An apparatus for attachment to a medicine container including:
A) a mechanical counting structure which can be manipulated to indicate to a consumer the number of times medicine in the container has been taken, and with said mechanical counting structure including moveable hands that resemble those of a clock.

12. The apparatus of claim 11 in which:
A) the apparatus is made of a molded flexible plastic material serving as a support structure for the mechanical counting structure such that the apparatus can be held in place attached to a medicine bottle by wrapping extensions of the support structure around the bottle.
